(19) United States
(12) Patent Application Publication
(10) Pub. No.: US 2001/0049727 A1
(43) Pub. Date: Dec. 6, 2001

(54) METHOD FOR EFFFICIENT AND SCALABLE INTERACTION IN A CLIENT-SERVER SYSTEM IN PRESENCE OF BURSTY CLIENT REQUESTS

(76) Inventors: BODHISATTAWA MUKHERJEE, WAPPINGERS FALLS, NY (US); SRINIVAS P. DODDAPANENI, EMMAUS, NY (US)

Correspondence Address: SCULLY SCOTT MURPHY AND PRESSER, RICHARD L CATANIA, 400 GARDEN CITY PLAZA, GARDEN CITY, NY, 11530

(21) Appl. No.: 09/181,386

(22) Filed: Oct. 28, 1998

(51) Int. Cl. G06F 15/16

(52) U.S. Cl. 709/219; 709/224

(57) ABSTRACT

A method for client-server interaction in a distributed computing environment. The computing environment may consist of a multiplicity of client computers, at least one server computer and a network connecting server and client computers. The server computer has some resources which the client computers need, alternatively the client computers run an application to request these resources. The client computers send requests for those resources to the server. The server aggregates those requests and dispatches the resource to the clients using a single multicast message. The server may check a threshold to determine if the threshold on server performance is exceeded. If the threshold is exceeded dispatches will be aggregated, however, if the threshold is not exceeded the request for the resource will be serviced immediately.

### BACKGROUND OF THE INVENTION

1. Field of the Invention

The invention relates generally to computer software, and in particular to method for distributing resources in client-server system where a group of geographically distributed clients are connected to a common server using a computer network.

2. Description of Prior Art

With the popularity of the Internet on the rise, client-server applications are being used by millions of people every day to perform various transactions in cyberspace. Such applications range from collaborative applications to e-commerce applications such as Internet auctions. Many client-server applications such as remote presentation and online auctions are inherently bursty, i.e., a burst of client requests arrive in the server simultaneously. For example, in a remote presentation application with a shared foil viewer, whenever a foil is flipped, all the clients request the server for the next foil at the same time. A similar behavior can be observed in auction applications, when a new item is being shown to the clients. One of the technical challenges in building such applications is performance and scalability of the server, and effective use of network bandwidth in presence of such bursts of client requests.

### SUMMARY OF THE INVENTION

The objective of the present invention is to reduce the amount of work performed by a server when a request for an arbitrary server resource is simultaneously initiated from multiple client locations.

This invention provides support for an efficient and scalable protocol between a client and the server in the presence of bursty requests initiated from multiple client locations in wide-area distributed environments such as the Internet.

The computing environment for utilizing the present invention, may consist of at least one server computer connected by a network, such as the Internet, to a multitude of client computers. The server computer having some resources which client computers need. Client computers execute an application to request client resources. Those requests for server resources are sent over the network to the server.

According to the inventive method, an application on a client computer determines what resources will be necessary for that client in the future and initiates a request for that resource by requesting that resource from the server. This application is configurable by defining values of parameters including a cache size, a network bandwidth, a sequence of requests, and an average time between successive requests.

The server aggregates client requests before dispatching the resource. The aggregation of requests routine of the present invention, makes use of parameters including maximum number of aggregate requests pending at a given time, maximum number of individual clients in any aggregate request, maximum time period before completion of building of an aggregate request. The aggregation of requests can be configured by providing values to these parameters. The aggregation of requests routine also logs data on individual requests received and on aggregate requests. After aggregating requests, the resource is simultaneously sent to all requesting clients using a single multicast message.

After the requested resource is received by the client computer, an inventive caching routine is used. The caching routine of the present invention has a garbage collection policy for reclaiming storage space used for storing resources that are no longer needed.

In another embodiment, the aggregation of requests is scalable. The server may check a threshold to determine if the threshold on server performance is exceeded. If the threshold is exceeded dispatches will be aggregated, however, if the threshold is not exceeded the request for the resource will be serviced immediately. The threshold value may be scalably adjusted.

### BRIEF DESCRIPTION OF DRAWINGS

The foregoing objects and advantages of the present invention may be more readily understood by one skilled in the art with reference being had to the following detailed description of a preferred embodiment thereof, taken in conjunction with the accompanying drawings wherein like elements are designated by identical reference numerals throughout the several views, and in which:

FIG. 1 is an example of a system having features of the present invention;

FIG. 2 depicts data structures for a cache and a cache allocation table;

FIG. 3 depicts data structure for a resource list;

FIGS. 4 and 5 are a flowchart of steps for pre-fetch of resources;

FIG. 6 is a flowchart of steps for requesting a resource on a client computer;

FIG. 7 is a flowchart of steps for receiving a resource on a client computer;

FIG. 8 is a flowchart of steps for aggregating requests from multiple client computers for same resource;

FIG. 9 is a flowchart of steps for closing an aggregate request and servicing the request using a multicast message; and

FIG. 10 is an example of a scalable embodiment of the present invention using a threshold to aggregate requests.

### DETAILED DESCRIPTION OF THE INVENTION

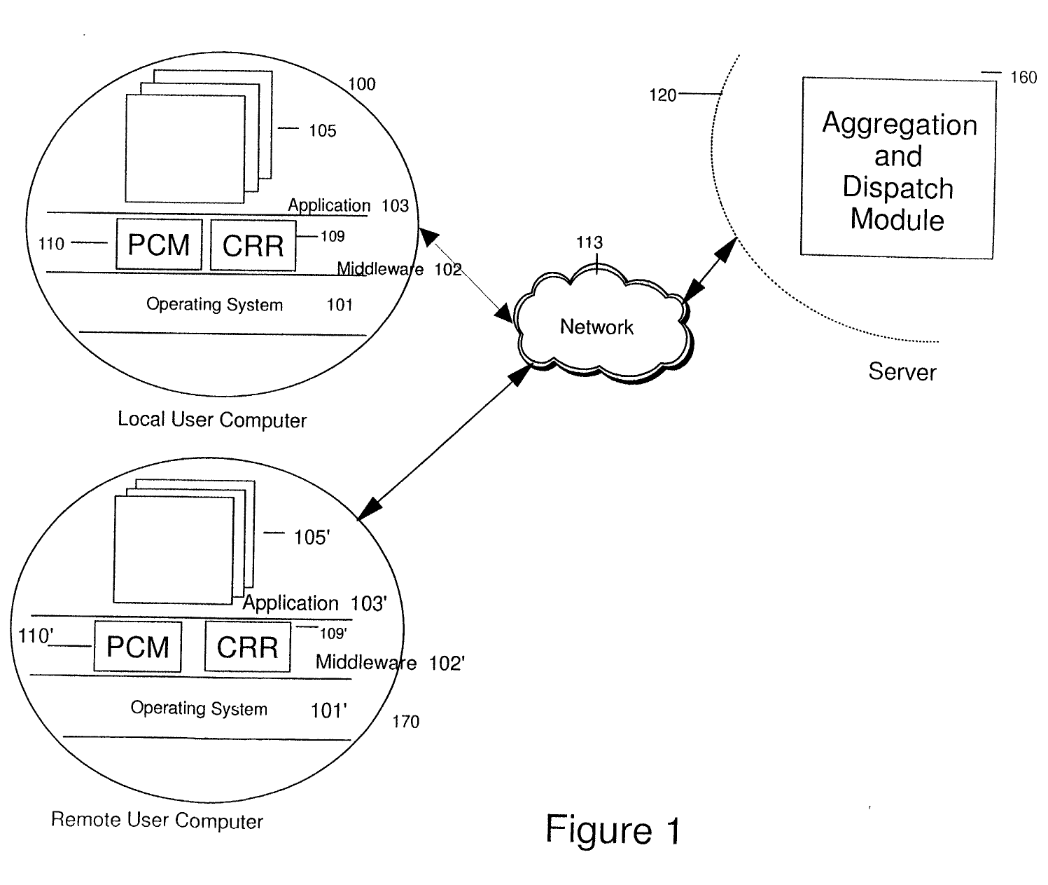

FIG. 1 shows the system of the present invention having a local client site 100, one or more remote client sites 170 and a server 120, all connected using a network 113. The network is used to communicate messages between clients and servers using a network specific protocol, e.g., the TCP/IP protocol is used when the Internet is used as the network.

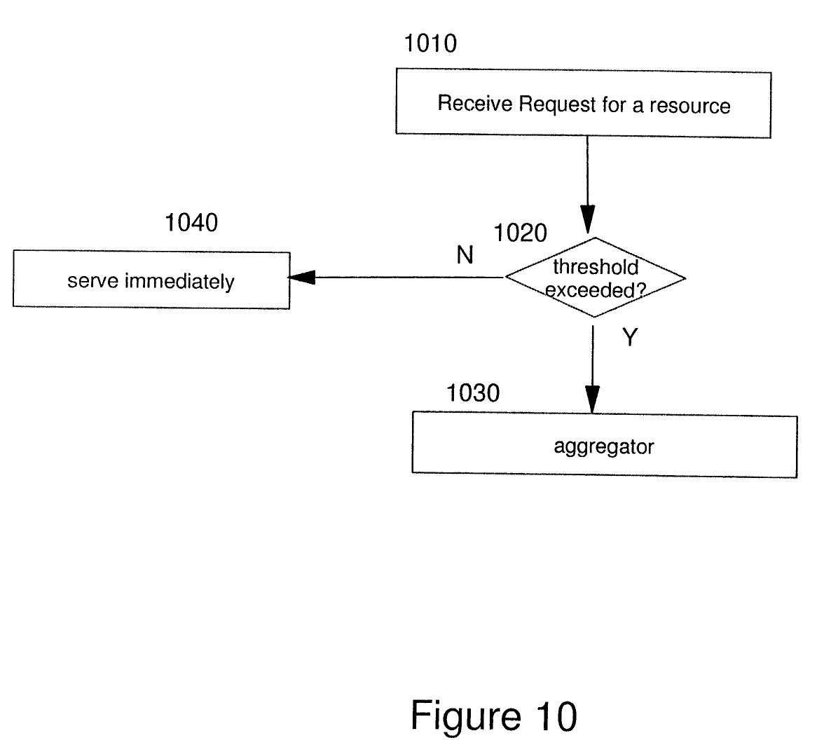

The server 120 can be either a client machine running the server or a dedicated server machine comprising an aggregation and dispatch module 160. Module 160 aggregates client requests received during a specific time interval. FIG. 10 shows the process flow diagram of the server 120 (FIG. 1). In a scalable embodiment of the invention, once a request for a resource is received at step 1010, a check is made at step 1020, to determine if a threshold on server performance is exceeded. For example, a typical threshold may be defined as the server work load being above ninety percent of server capacity. If the threshold is exceeded, at step 1030 the request is forwarded to the aggregation and dispatch module 160 (FIG. 1). Otherwise, at step 1040 the request is serviced immediately. Aggregated requests are serviced as soon as certain conditions are met. As shown in FIG. 1, each client site, 100, 170 includes an operating system layer 101, 101′, a middleware layer 102, 102′, and an application layer 103, 103′. The operating system layer 101, 101′ can be any available computer operating system such as AIX, Windows 95, Windows NT, SUN OS, Solaris, and MVS. The middleware layer implements domain specific system infrastructures on which applications can be developed. The application layer includes client-server application components 105, 105′. These applications are programmed using the services provided by a pre-fetching and caching module (PCM) 110, 110′, and a client request receiver module (CRR) 109, 109′. Both the PCM 110, 110′ and the CRR 109, 109′ can belong to the middleware layer 102, 102′ or the application layer 103, 103′. An application 105, 105′ uses the support of the PCM module 110, 110′ to initiate a request for a resource to a server before the resource is really needed. The CRR module 109, 109′ is used to manage a request for a resource to an appropriate server 120.

Pre-fetching and Caching

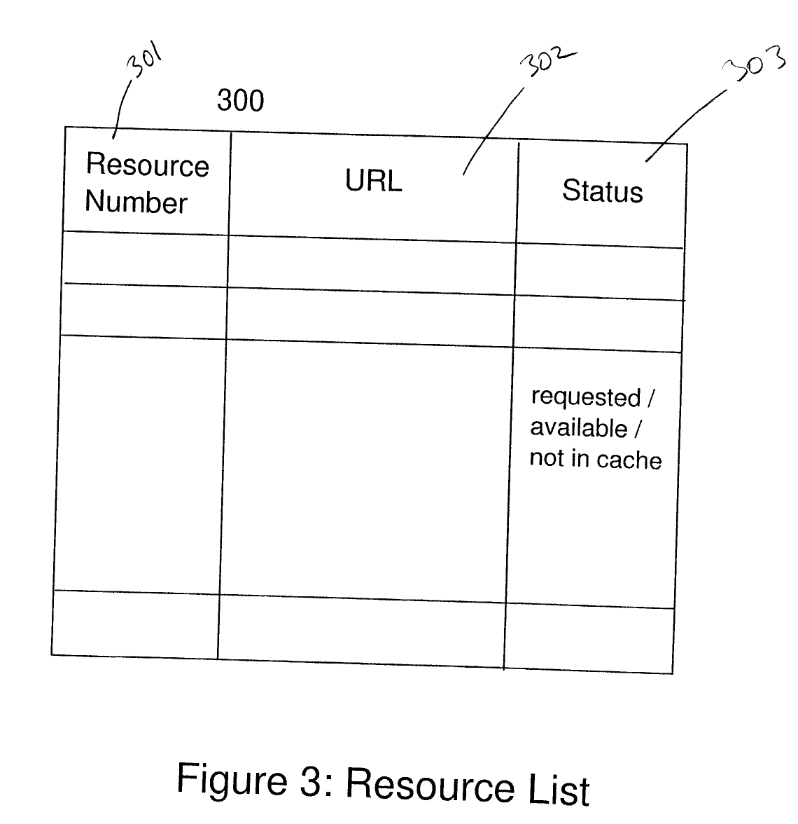

FIG. 3 shows a client maintained list of resources called Resource List 300. The Resource List 300 contains resources in the order they are likely to be needed by an application 105, 105′ (FIG. 1). Each resource has a unique resource number 301, a universal resource locator (URL) 302. Further Resource List 300 has a slot 303 for storing the status of each resource which may be one listed as available, requested, and not in cache.

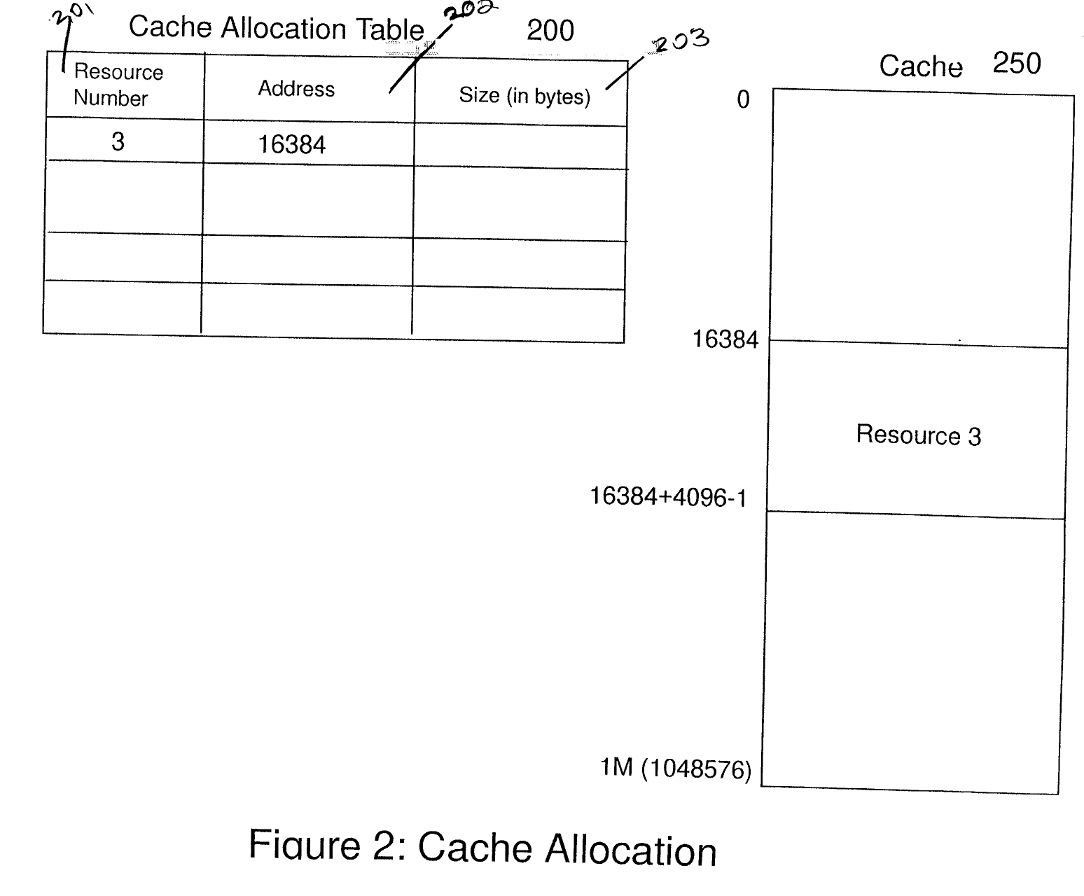

FIG. 2 shows a cache 250, provided in each client computer 100, 170 (FIG. 1), to store resources that are pre-fetched for a later use by an application 105, 105′ (FIG. 1). A cache allocation table 200 is implemented for each cache 250 that holds a list of resources currently in cache 250. For each resource 201 in cache 250, a starting address 202 and a size 203 are stored as well. Steps for computing whether there is enough contiguous space to hold a resource of a given size, may utilize the data provided in the cache allocation table 200.

The Server of the present invention aggregates requests received during a time interval, and will not reply to the requests until the end of that time interval. Therefore, it is more likely that the latency seen by the client systems would increase. The PCM module 110 (FIG. 1) alleviates the problem of requesting resources before they are really needed by the application by pre-fetching resources. It is desirable to cache as many resources as possible. However, the amount of memory available for storing these resources is limited. Therefore, the pre-fetch steps initiate a request for a new resource whenever there is enough unused memory in the resource cache.

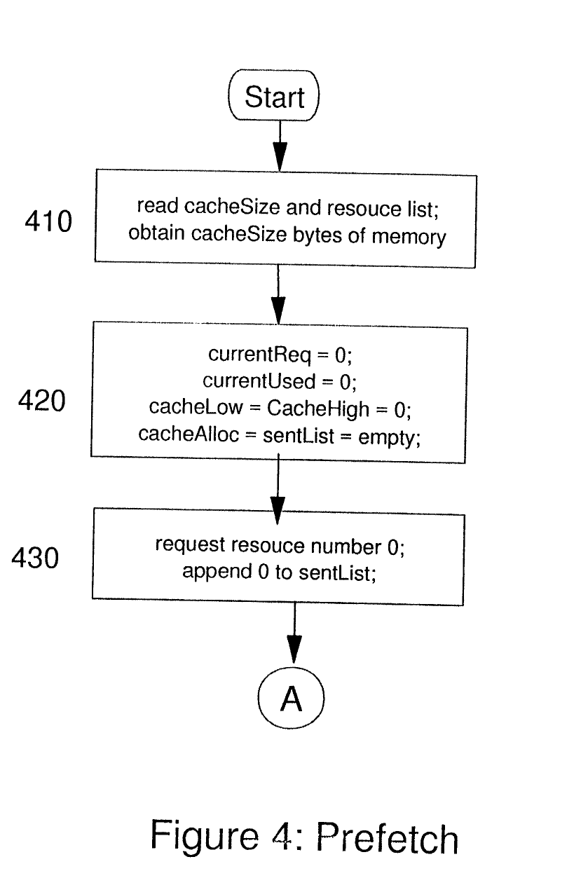

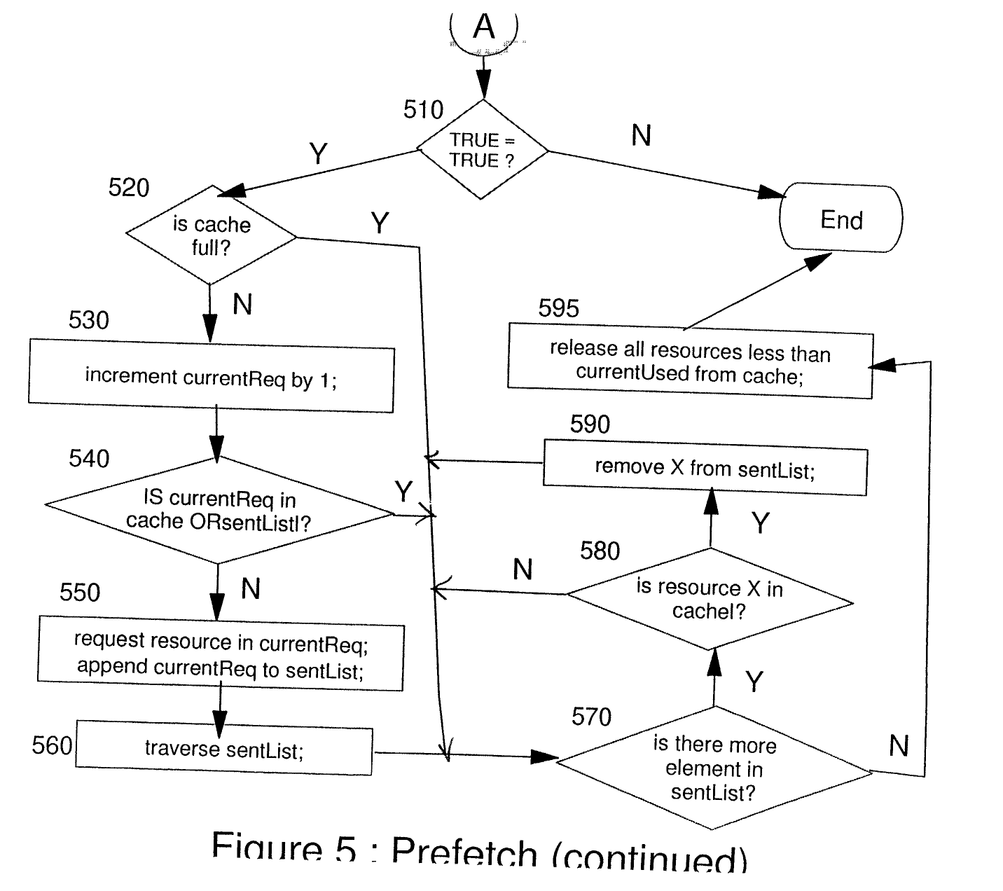

FIGS. 4 and 5 show a flowchart of steps for pre-fetching resources implemented in the PCM module 110, 110′ (FIG. 1). First, as shown in FIG. 4, the size of the available cache, cacheSize, and a list of resources, resourceList, are read and cacheSize bytes of memory to be used as cache are obtained at step 410. Application 105, 105′ (FIG. 1) updates a common currentUsed variable with the resource number currently in use. Working variables currentReq, currentUsed, cacheLow, cacheHigh, cacheAlloc, and sentList are initialized at step 420. A request for the very first resource is initiated in step 430.

FIG. 5 shows the continuation of the PCM module 110, 110′ (FIG. 1) flow started in FIG. 4. A loop is initiated at step 510. At steps 520 a test determines if the cache is full. If it is, the control passes to step 570. Otherwise, currentReq variable is incremented at step 530 and a test is performed at step 540 to determine if the resource is either in cache or in sentList. If the resource is in cache or in sentList the control is transferred to step 570. Otherwise, at step 550 the next resource is requested.

The sentList is traversed at step 560, and a test is performed at step 570 to determine if there are more elements in sentList. If there are no more elements, the control is passed to step 595 where all resource numbers in cache that are less than currentUsed, are released after which the program is terminated. Otherwise, at step 580 a test is performed to determine if the resource exists in cache. If the resource does not exist, the control returns to step 570 for further processing. Each resource number in the sentList that also exists in cache is removed from the sentList at step 590, and the control is once again returned to step 570.

Client Request-Receive

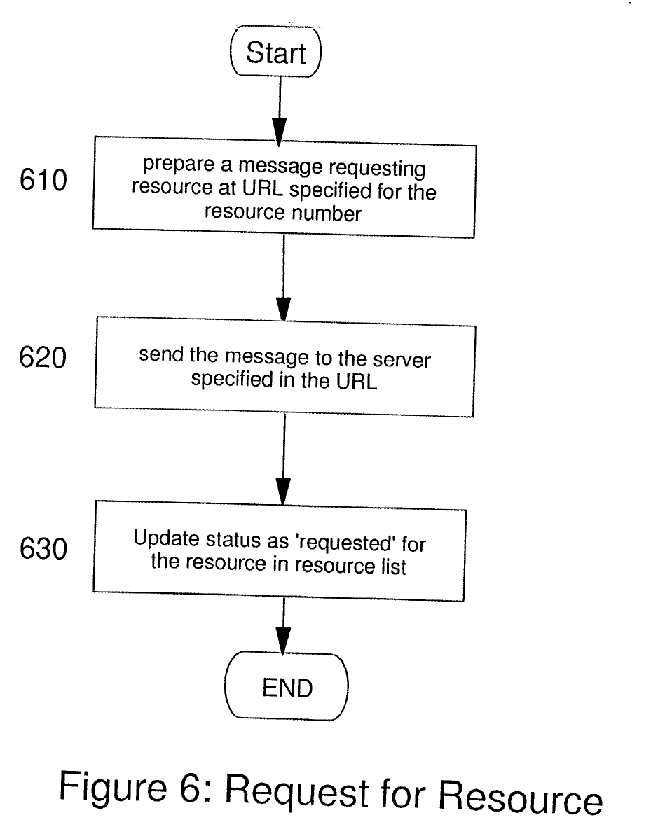

FIG. 6 shows a flowchart for requesting a resource. At step 610, a message is prepared containing information about the resource requested from a server. The message is then sent, at step 620, to the appropriate server specified in the URL for the resource. At step 630, the status of the resource is updated to requested in resourceList 300 (FIG. 3), after which the program is terminated.

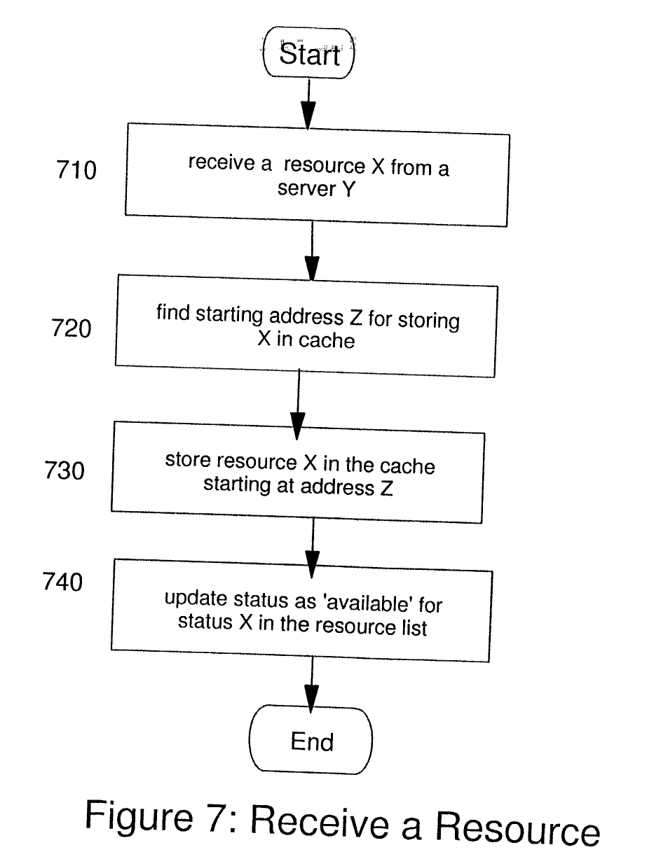

FIG. 7 shows a flowchart for receiving a resource in CRR module 109, 109′ (FIG. 1). A resource X from a server Y is received at step 710. The starting address in cache for storing the resource X is found at step 720 and at step 730 the resource is stored in cache. At step 740, the status of the resource X is updated to available.

Server Aggregation and Dispatch

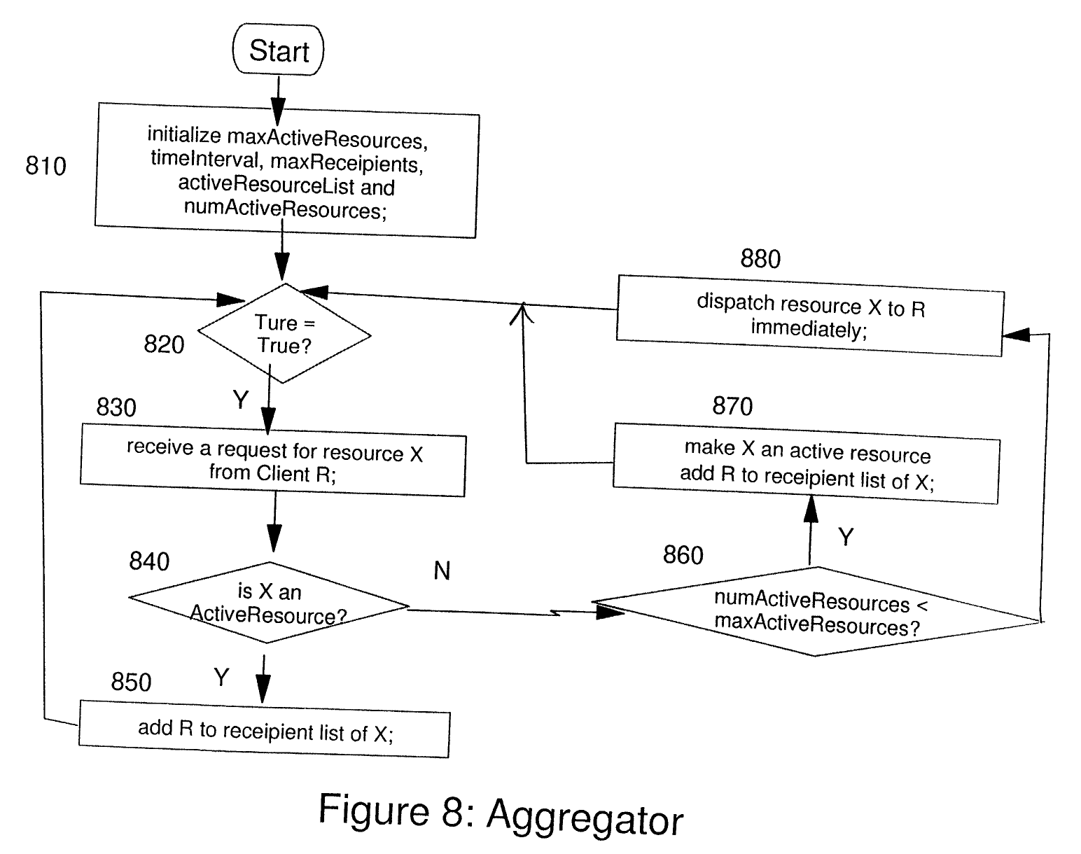

FIG. 8 shows a flowchart for aggregation and dispatch module 160 (FIG. 1) for aggregating requests received for same resource. A number of working variables, e.g., maxActiveResources, timeinterval, maxRecipients, ActiveResourceList, and numActiveResources are initialized in step 810. A loop is initialized in step 820. After a request for resource X is received from client R at step 830, a test is performed at step 840 to determine if X is an active resource. If X is an active resource then client R is added to the target list of resource X at step 850 and the control returns to the top of the loop at step 820. Otherwise, a test is made at step 860 to determine if the number of active resources, numActiveResources is less then the maximum number of active resources, maxActiveResources. If the number of active resources is less then the maximum number of active resources then the resource X is made an active resource at step 870, and the control returns to the top of the loop at step 820. However, if the number of active resources is equal to, or exceeds the maximum number of active resources then, at step 880, resource X is sent to client X immediately, after which the control returns to the top of the loop at step 820.

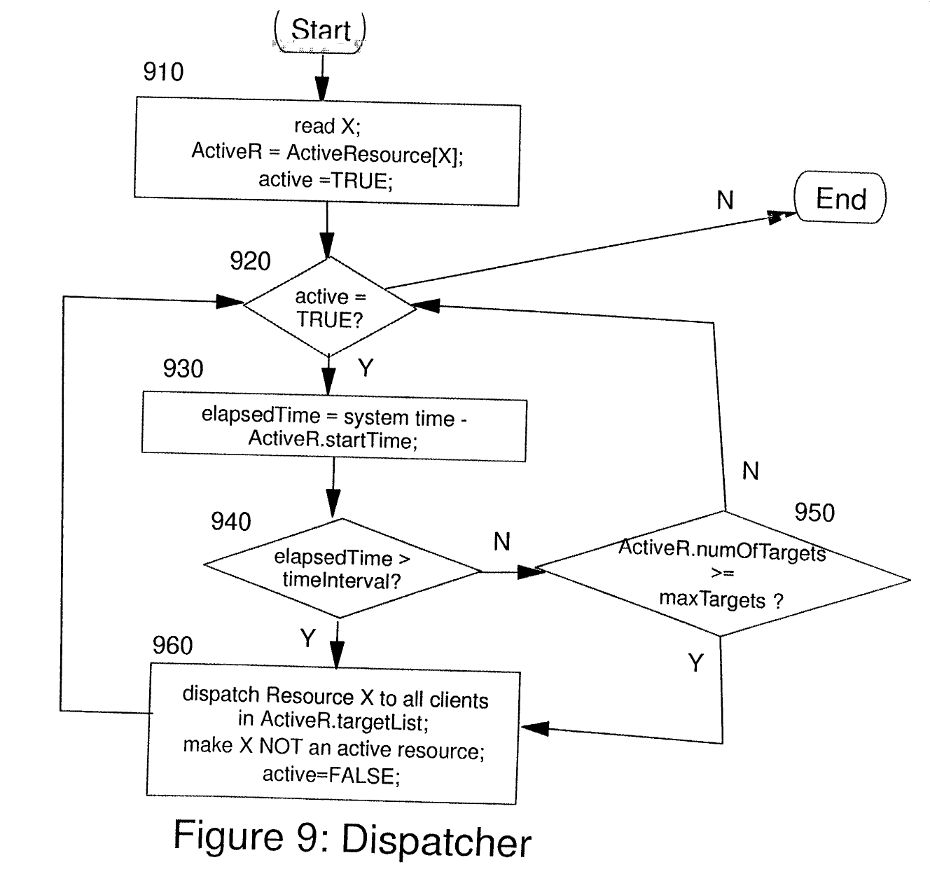

FIG. 9 shows a flowchart of a routine in an aggregation and dispatch module 160 for dispatching a resource to the list of targets in an aggregate request using a single multicast message. An instance of this routine is running for each active resource X. Initialization of variables and the reading of the ActiveResource is performed at step 910. A loop at Step 920 will repeat while resource X is active, if the resource is not active the program will terminate. Time elapsed since the time first target client is added, elapsedTime is computed at step 930. A test at step 940 determines whether the elapsed time is greater than the time-out interval. If it is, at step 960 resource X is sent to each client in the target list and is made not active. At this point the control of the program passes to step 920, and the loop repeats. If at step 940 the elapsed time is less than or equal to the time-out interval, then a test at step 950 determines whether the number of targets is larger than or equal to maximum limit of targets. If it is not, the control of the program passes to step 920, and the loop repeats. However, if the number of targets is larger than or equal to maximum limit of targets the control passes to step 960 and the processing as described above is performed.

While the invention has been particularly shown and described with respect to illustrative and preferred embodiments thereof, it will be understood by those skilled in the art that the foregoing and other changes in form and details may be made therein without departing from the spirit and scope of the invention that should be limited only by the scope of the appended claims.

Having thus described our invention, what we claim as new, and desire to secure by letters patent is:

1. A method for distributing resources in a client-server computing environment comprising a server computer having one or more resources, plurality of client computers each running a request application to request said resources, and a network means for connecting said server and said client computers, the method comprising steps of:
said request application determining a single resource of said resources which will be needed by said client in the future;
communicating requests for said single resource from each said client to said server;
said server collecting said requests for a single resource into an aggregated request;
said server dispatching said single resource according to said aggregated requests to each said client over said network using a single multicast message; and
said client caching said single resource.

2. The method of claim 1, wherein said plurality of client computers comprises remote client computers and local client computers.

3. The method of claim 2, wherein each of said client computers is running a receive application to receive said resources.

4. The method of claim 3, wherein a status of said communicated requests may be checked using query functions.

5. The method of claim 4, wherein said step for determining depends upon one or more configurable system parameters, including a cache size, a network bandwidth, a sequence of said requests for said single resource, and an average time between successive requests for said single resource.

6. The method of claim 5, wherein said caching step further comprises a garbage collection policy for reclaiming storage space used for cashing resources that are no longer needed.

7. The method of claim 6, wherein said collecting of said requests step depends upon one or more status parameters, said status parameters include maximum number of said requests for a single resource pending at a given time, maximum number of individual client computers that communicated said requests for a single resource, maximum time period before completion of said aggregated request.

8. The method of claim 7, wherein said collecting of said requests is configured by providing values to said status parameters.

9. The method of claim 8, wherein, said collecting of said requests step further comprises a step of logging data on individual requests for a single resource received and on said aggregated request.

10. A method for distributing resources in a client-server computing environment comprising a server computer having one or more resources, plurality of client computers each running a request application to request said resources, and a network means for connecting said server and said client computers, the method comprising steps of:
said request application determining a single resource of said resources which will be needed by said client in the future;
communicating requests for said single resource from each said client to said server;
determining if a server performance exceeds a threshold;
said server dispatching said single resource immediately according to said request to said client over said network if said threshold is not exceeded;
said server collecting said requests for a single resource into aggregated requests, and dispatching said single resource according to said aggregated requests to each said client over said network using a single multicast message if said threshold is exceeded; and
said client caching said single resource.

11. The method of claim 10, wherein, said threshold is scalable.

12. A computer program device readable by a machine, tangibly embodying a program of instructions executable by a machine to perform method steps for distributing resources in a client-server computing environment comprising a server computer having one or more resources, plurality of client computers each running a request application to request said resources, and a network means for connecting said server and said client computers, the method comprising steps of:
said request application determining a single resource of said resources which will be needed by said client in the future;
communicating requests for said single resource from each said client to said server;
said server collecting said requests for a single resource into an aggregated request;
said server dispatching said single resource according to said aggregated requests to each said client over said network using a single multicast message; and
said client caching said single resource.

13. The method of claim 12, wherein said plurality of client computers comprises remote client computers and local client computers.

14. The method of claim 13, wherein each of said client computers is running a receive application to receive said resources.

15. The method of claim 14, wherein a status of said communicated requests may be checked using query functions.

16. The method of claim 15, wherein said step for determining depends upon one or more configurable system parameters, including a cache size, a network bandwidth, a sequence of said requests for said single resource, and an average time between successive requests for said single resource.

17. The method of claim 16, wherein said caching step further comprises a garbage collection policy for reclaiming storage space used for cashing resources that are no longer needed.

18. The method of claim 17, wherein said collecting of said requests step depends upon one or more status parameters, said status parameters include maximum number of said requests for a single resource pending at a given time, maximum number of individual client computers that communicated said requests for a single resource, maximum time period before completion of said aggregated request.

19. The method of claim 18, wherein said collecting of said requests is configured by providing values to said status parameters.

20. The method of claim 19, wherein, said collecting of said requests step further comprises a step of logging data on individual requests for a single resource received and on said aggregated request.

21. A method for distributing resources in a client-server computing environment comprising a server computer having one or more resources, plurality of client computers each running a request application to request said resources, and a network means for connecting said server and said client computers, the method comprising steps of:
said request application determining a single resource of said resources which will be needed by said client in the future;
communicating requests for said single resource from each said client to said server;
determining if a server performance exceeds a threshold;
said server dispatching said single resource immediately according to said request to said client over said network if said threshold is not exceeded;
said server collecting said requests for a single resource into aggregated requests, and dispatching said single resource according to said aggregated requests to each said client over said network using a single multicast message if said threshold is exceeded; and
said client caching said single resource.

22. The method of claim 21, wherein, said threshold is scalable.
